(19) United States
(12) Patent Application Publication
(10) Pub. No.: US 2016/0147852 A1
(43) Pub. Date: May 26, 2016

(54) SYSTEM AND METHOD FOR ROUNDING COMPUTER SYSTEM MONITORING DATA HISTORY

(71) Applicants: Arndt Effern, Sinsheim (DE); Steffen Siegmund, St. Leon-Rot (DE); Ralf Stauffer, Schwegenheim (DE); Guenter Briam, Wiesloch (DE)

(72) Inventors: Arndt Effern, Sinsheim (DE); Steffen Siegmund, St. Leon-Rot (DE); Ralf Stauffer, Schwegenheim (DE); Guenter Briam, Wiesloch (DE)

(21) Appl. No.: 14/549,960

(22) Filed: Nov. 21, 2014

(51) Int. Cl. G06F 17/30

(52) U.S. Cl. CPC G06F 17/30569; G06F 17/30312

(57) ABSTRACT

According to some embodiments, monitoring data for a computer system may be received, the monitoring data including at least one d digit operating performance parameter of the computer system. A rounding engine processor may automatically transform the monitoring data into rounded monitoring data such that the d digit operating performance parameter is rounded to preserve only the m most significant digits, where m is less than d. The rounded monitoring data may then be stored within a rounded monitoring data history of a history storage unit.

### BACKGROUND

A computer system may include applications that are released and able to run on various combinations of database systems, operating systems, virtualization layers and cloud services, such as Infrastructure-as-a-Service (“IaaS”). Various infrastructure components of the computer system may be instrumented and monitored to help keep business processes up and running. While a snapshot of current monitoring data may provide a relatively good impression of current system behavior, monitoring data history for a relatively long period of time may better help determine how the behavior of the computer system changes over time. For example, a monitoring data history of more than one year may be maintained, which might add up to several 100 Giga-Bits (“GB”) of raw data for various elements of the computer system. Keeping such a substantial amount of data, however, may be expensive and increase the Total Cost of Ownership (“TCO”) of the computer system.

### BRIEF DESCRIPTION OF THE DRAWINGS

FIG. 1 is a block diagram of a computer system including a monitoring platform.

FIG. 2 is a table illustrating a set of monitoring data operating performance parameters for two computer systems.

FIG. 3 is a table illustrating a set of monitoring data operating performance parameters for the two hosts of FIG. 2 combined.

FIG. 4 is a flow diagram of a method according to some embodiments.

FIG. 5 is a block diagram of a computer system including a monitoring platform in accordance with some embodiments.

FIG. 6 is a graph illustrating various monitoring data rounding scenarios in accordance with some embodiments.

FIG. 7 is a block diagram of a monitoring platform according to some embodiments.

FIG. 8 is a tabular representation of monitoring data and rounded monitoring data in accordance with some embodiments.

FIG. 9 is a table of an example illustrating various rounding scenarios according to some embodiments.

FIG. 10 is a flow diagram of a rounding method according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

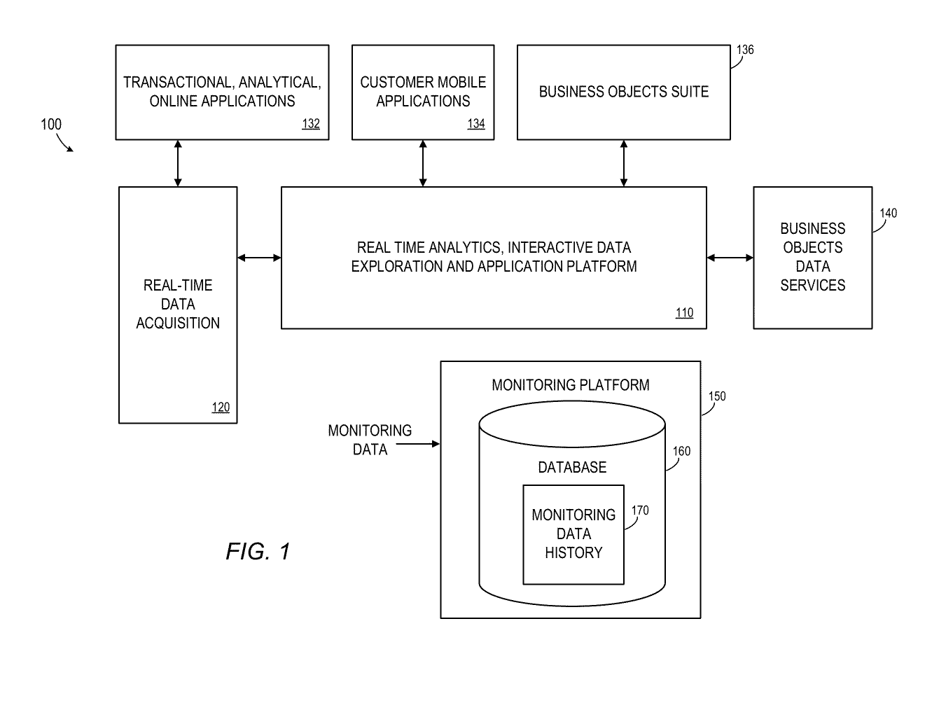

In some cases, a computer system may include applications that are released and able to run on various combinations of database systems, operating systems, virtualization layers and cloud services, such as IaaS. By way of example, only FIG. 1 is a block diagram of a computer system 100 including a real time analytics, interactive data exploration and application platform 110 that communicates with a real-time data acquisition device 120. The application platform 110 might be associated with, for example, the High-Performance ANalytic Appliance (“HANA”) in-memory, column-oriented, relational database management system developed and marketed by SAP SEC®. The application platform 110 may include, for example, an OnLine Analytical Processing (“OLAP”) engine, a predictive engine, a spatial engine, and/or application logic and rendering. The real-time data acquisition device 120 may include landscape transformation, a replication server, and/or an event stream processor. According to some embodiments, the application platform 110 and/or real-time data acquisition device 120 may exchange information with transactional, analytical, online applications 132. The application platform may also exchange information with customer mobile applications 134 (e.g., associated with mobile platforms), a business object suite 136 (e.g., associated with exploration, reporting, dashboarding, predictive functions, and/or mobile versions) and/or business objects data services 140.

Various infrastructure components of the system 100 may be instrumented and monitored to help keep business processes up and running. While a snapshot may provide a relatively good impression of current system 100 behavior, a monitoring platform 150 may receive monitoring data and store information into a storage unit 160 as monitoring data history 170 for a relatively long period of time to better determine how the behavior of the computer system 100 changes over time. For example, a monitoring data history 170 of more than one year may be maintained, which might add up to several 100 GB of raw data for various elements of the computer system 100. Keeping such a substantial amount of data, however, may be expensive and increase the TCO of the computer system 100.

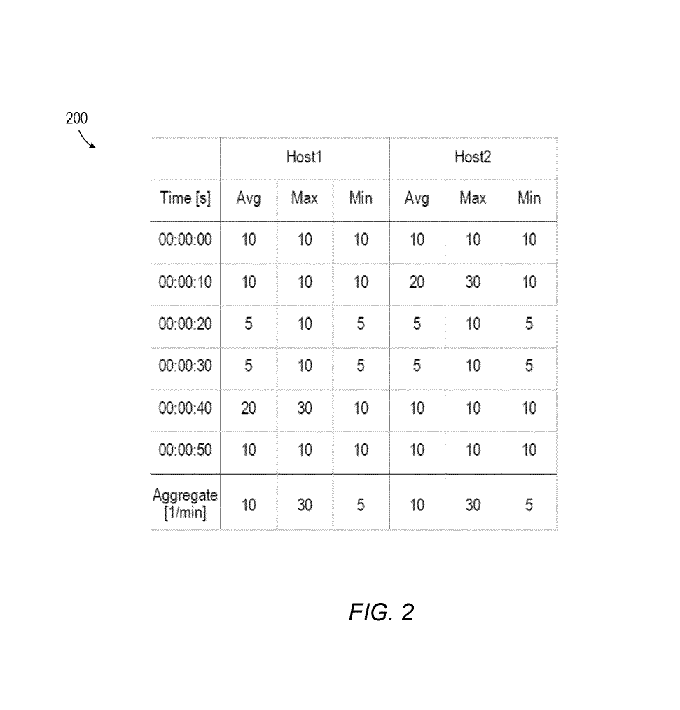

One approach to reducing the amount of stored monitoring data history 170 is to aggregate the information. For example, after one minute the raw data that was originally collected every 10 seconds may be aggregated on a minute basis. FIG. 2 is a table 200 illustrating a set of monitoring data operating performance parameters for two computer systems labeled “Host1” and “Host2.” With this type of aggregation, the volume of monitoring data can be significantly reduced. Unfortunately, aggregating information is associated with a loss of detailed information. Relatively quick ups and downs within the aggregation period are smoothed out and may become invisible. As can be seen in the Aggregate row in the table 200 of FIG. 2, the average column aggregate values of Host1 and Host2 are both 10, even though the original data samples were different.

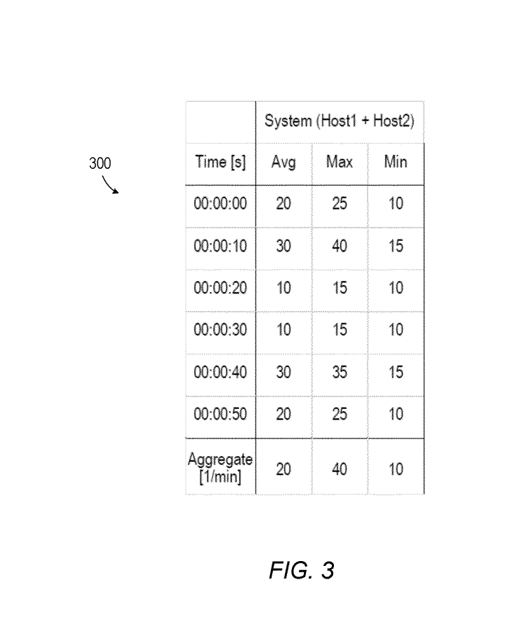

To attempt to partly compensate this accuracy loss, maximum and minimum values associated with an aggregated time period may also be maintained (as illustrated by the “Max” and “Min” columns in the table 200 of FIG. 2). This approach, however, may increase the volume of stored data by a factor of three. Moreover, keeping maximum and minimum values for each of Host1 and Host2 cannot later be used to accurately calculate combined maximum or minimum values of both hosts (e.g., to obtain an overall view of the computer system). FIG. 3 is a table 300 illustrating a set of monitoring data operating performance parameters for the two hosts of FIG. 2 combined. As can be seen, summing the maximum values of each host ends up with a value of 60 (e.g., the sum of both overall aggregate values of 30), whereas the correct combined value should have been 40 (because the real maximum value that occurred at time “00:0010” cannot be determined by the aggregate information in the table 200 of FIG. 2).

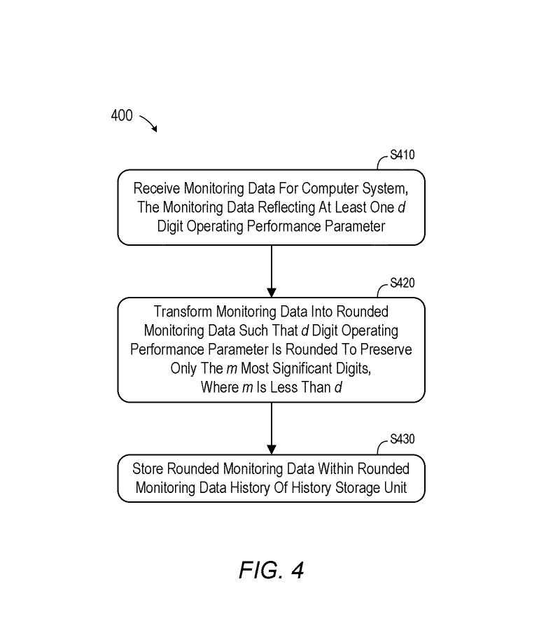

To avoid such problems, FIG. 4 comprises a flow diagram of a method or process 400 according to some embodiments. In some embodiments, various hardware elements of a monitoring platform execute program code to perform the method 400. The method 400 of FIG. 4 and all other processes mentioned herein may be embodied in processor-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software. Further note that the steps of the methods described herein may be performed in any order that is practical.

At S410, monitoring data for a “computer system” may be received, the monitoring data including at least one d digit operating performance parameter of the computer system. As used herein, the phrase “computer system” may refer to a system that includes, for example, a database system, an operating system, a virtualization layer, a cloud service, an infrastructure as a service platform, a real-time analytics, interactive data exploration and application platform, a real time data acquisition platform, a transactional, analytical, online application, a customer mobile application, a business object suite, and/or a business objects data service.

At S420, a rounding engine may access the monitoring data and transform the monitoring data into rounded monitoring data such that the d digit operating performance parameter is rounded to preserve only the m most significant digits, m being less than d. Consider, for example, a 6 digit operating performance parameter of “123456” that is to be rounded to preserve only the 3 most significant digits. In this case, the rounding engine would transform “123456” into “123000.” Now consider, for example, a 6 digit operating performance parameter of “123456” that is to be rounded to preserve the 4 most significant digits. In this case, the rounding engine would transform “123456” into “123500.” According to some embodiments, a particular digit may be rounded to the nearest integer. In other approaches, a digit might always be rounded down (or up). Note that rounding monitoring data may be created for each monitoring data that is received (that is, aggregation or average values may be avoided).

At S430, the rounded monitoring data may then be stored into a history storage unit. The history storage unit may, for example, store the rounded monitoring data into a rounded monitoring data history. The history storage unit may comprise, for example, columnar data storage in an in-memory database. The rounded monitoring data history in the history storage unit may then later be retrieved and used to determine, for example, a standard aggregation, a sum, an exception aggregation, a maximum value, and/or a minimum value. Note that separate rounded monitoring data history may be maintained for multiple computer systems (and the information about each computer system may later be combined and/or analyzed as appropriate).

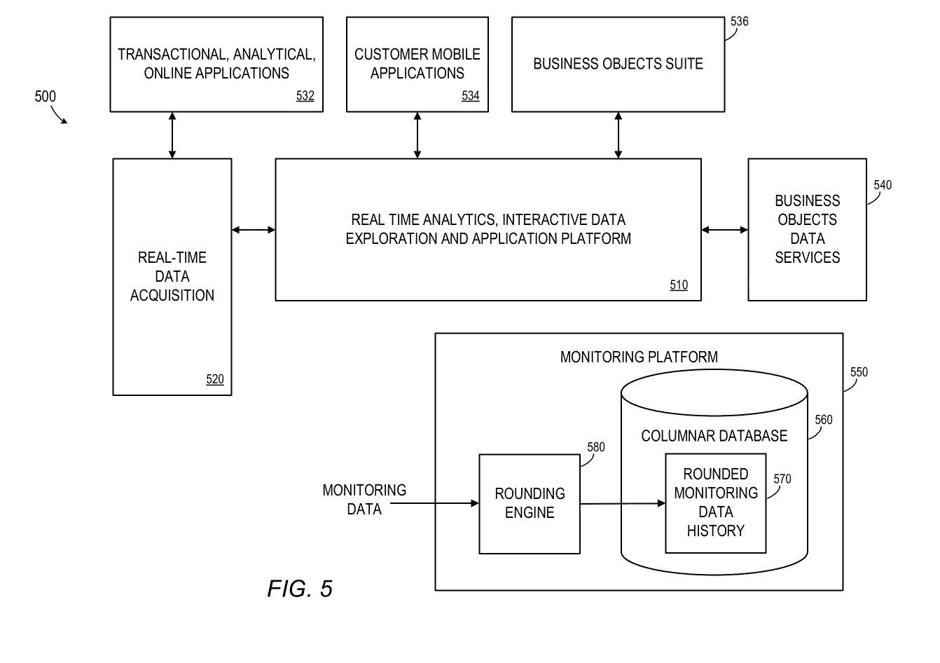

FIG. 5 is a block diagram of a system 500 including a monitoring platform 550 in accordance with some embodiments. As before, the computer system 500 may include a real time analytics, interactive data exploration and application platform 510 that communicates with a real-time data acquisition device 520. The application platform 510 may include, for example, an OLAP engine, a predictive engine, a spatial engine, and/or application logic and rendering. According to some embodiments, the application platform 510 and/or real-time data acquisition device 520 may exchange information with transactional, analytical, online applications 532. The application platform may also exchange information with customer mobile applications 534 (e.g., associated with mobile platforms), a business object suite 536 (e.g., associated with exploration, reporting, dashboarding, predictive functions, and/or mobile versions) and/or business objects data services 540.

The computer system 500 may include one or more data sources, such as a query-responsive data source or a source that is or becomes known, including but not limited to a Structured-Query Language (“SQL”) relational database management system. The data source may comprise a relational database, a multi-dimensional database, an eXtendable Markup Language (“XML”) document, or any other data storage system storing structured and/or unstructured data. The data of the data source may be distributed among several relational databases, dimensional databases, and/or other data sources. Embodiments are not limited to any number or types of data sources. For example, the data source may comprise one or more OLAP databases, spreadsheets, text documents, presentations, etc.

In some embodiments, a data source may be implemented in Random Access Memory (e.g., cache memory for storing recently-used data) and one or more fixed disks (e.g., persistent memory for storing their respective portions of the full database). Alternatively, the data source may implement an “in-memory” database, in which volatile (e.g., non-disk-based) memory (e.g., Random Access Memory) is used both for cache memory and for storing its entire respective portion of the full database. In some embodiments, the data of the data source may comprise one or more of conventional tabular data, row-based data, column-based data, and object-based data. The data source may also or alternatively support multi-tenancy by providing multiple logical database systems which are programmatically isolated from one another. Moreover, the data of the data source may be indexed and/or selectively replicated in an index to allow fast searching and retrieval thereof.

A rounding engine 580 in the monitoring platform 550 may receive monitoring data, round the monitoring data to preserve a pre-determined number of most significant digits, and store the rounded information into a columnar database storage unit 560 as rounded monitoring data history 570. The rounded monitoring data history 570 may represent a relatively long period of time and may facilitate a determination about how the computer system 500 behavior changes over time. Note that such an approach may avoid aggregation and utilize efficient compression capabilities of columnar data storage in an in-memory database. For example, a columnar database may have relatively good compression ratio when the table columns contain many duplicates. Unfortunately, accurate raw data generally does not lead to many duplicates. In contrast, rounded raw data does generally include many duplicates depending on the number of digits that are rounded. If only the first digit of a fixed-length number (counting from left) is maintained, there will only be 10 different values per column. If the second digit of the fixed-length number is also maintained, there will be a maximum of 100 different values per column, etc.

Assuming a normal deviation of rounding errors, a deviation of the rounded operating performance parameters as compared to the operating performance parameters prior to rounding is given by the following equation:

$$σ = \sqrt{\frac{1}{n * ( n - 1 )} * {\sum }_{1}^{N} ( {X}_{i} - {y}_{i} )}$$

where σ is the deviation, X is the operating performance parameter, y is the rounded operating performance parameter, and N is the number of times monitoring data was received. Note that the formula may comprise a calculation of a standard deviation of a set of normal distributed data records. Xᵢ represents the original data records (8 digits, without any rounding), and Yᵢ represents the rounded data records. The term (Xᵢ-Yᵢ) represents the variance of both original and rounded data records, and it describes how much the rounded data record deviated from the original data record. Calculating the standard deviation in this way may provide an estimate of how much deviation can be expected between the original and rounded data records after aggregation (sum, average) for a data set with n data records. When the size of collected data is a problem, the data may be aggregated (sum up or average data records that are collected each minute to an aggregated data record for each hour, for instance) or the precision of data records may be reduced (rounding or filtering data). The formula illustrates that the deviation of aggregated rounded and aggregated original data may be negligible when the number of data records is high enough. Thus, losing data precision may provide a substantially better alternative as compared to aggregating monitoring data upfront.

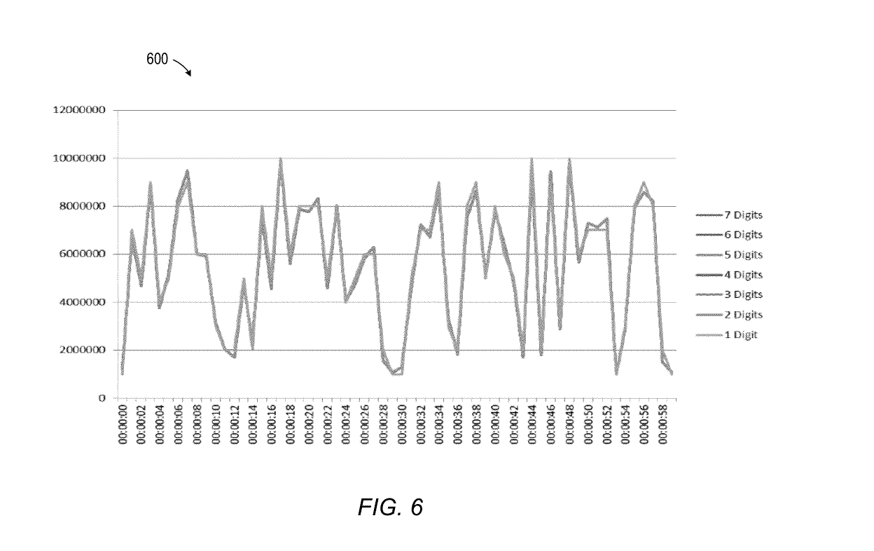

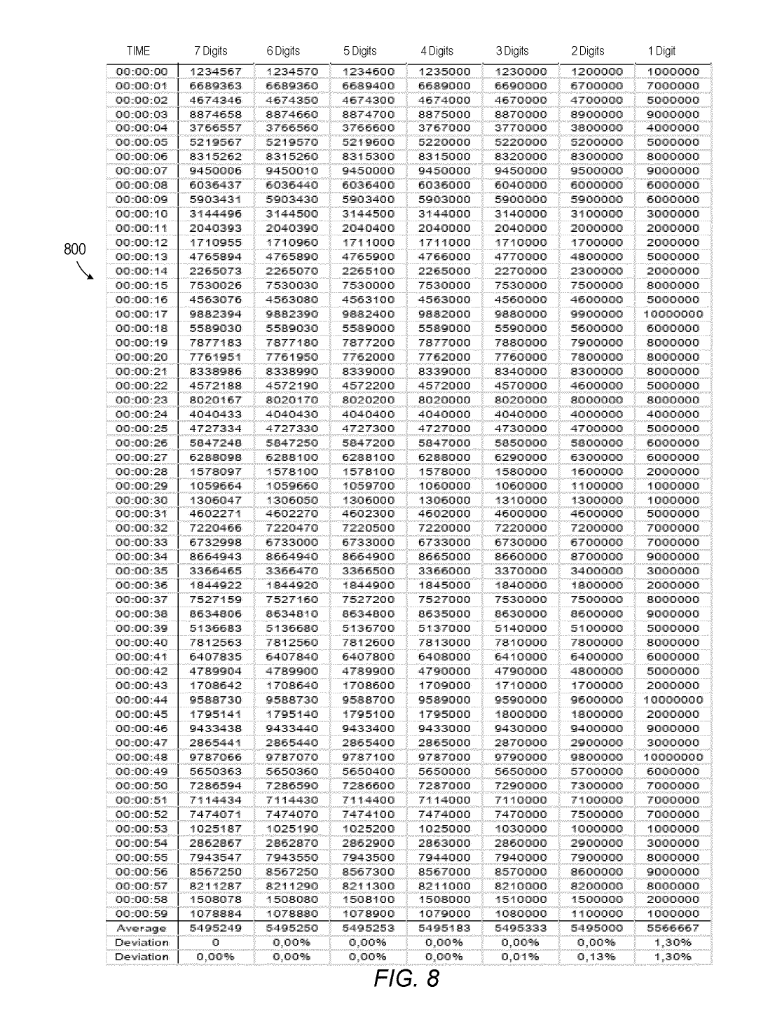

FIG. 6 is a graph 600 illustrating various monitoring data rounding scenarios m (rounding to 1 through 7 digits) in accordance with some embodiments. In particular, the graph 600 illustrates an example of 60 data records that were randomly generated in a data range between 1 and 10 million. The graph 600 shows the generated raw data in comparison to a variety of rounded values each at different accuracy levels. Note that the graph corresponds to the raw data samples and the corresponding rounded values of illustrated in FIG. 8. Further note that deviations only become visible when the rounding accuracy is 2 or 1 digits (that is, each of the curves associated with 3 through 7 digits are almost congruent and their deviation is below the graphical resolution of FIG. 6).

On an aggregated level, the deviation of rounded data compared to generated original data may be negligible, even for relatively low accuracy levels. As a result, aggregations may continue to work with rounded data with almost no difference as compared to original, un-rounded data. Moreover, the deviation of single raw data records as compared to rounded records at digit 2 may acceptable for the purpose of root cause analysis of a computer system, because the maximum deviation may be substantially 5%. Because the rounded data is kept at the original sampling rate, any smoothing effect may be avoided and analysis may still calculate standard aggregations, like sums, and exceptional aggregations, like maximum and minimum values, in all directions.

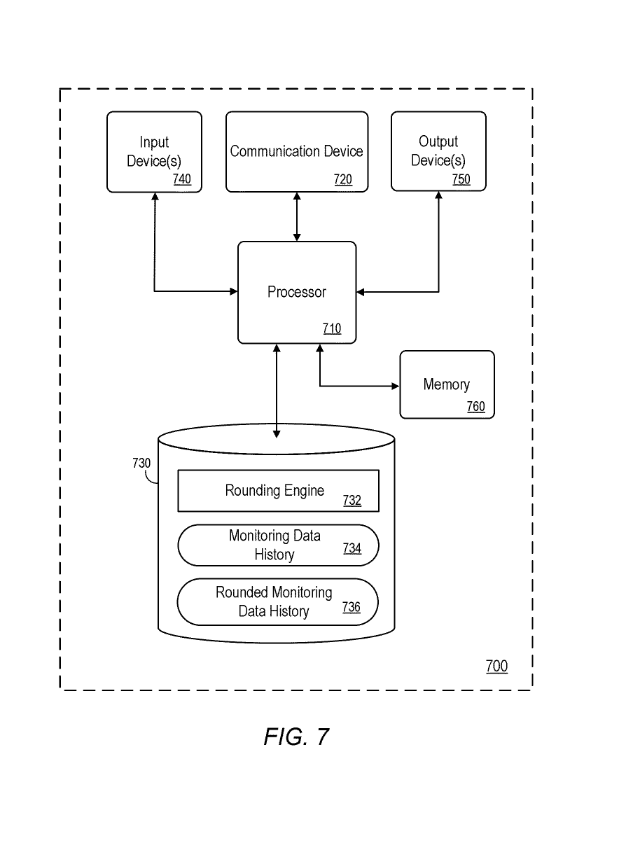

Note that embodiments of a monitoring platform having a rounding engine may be implemented in any of a number of different ways. For example, FIG. 7 is a block diagram of a monitoring platform apparatus 700 according to some embodiments. The apparatus 700 may comprise a general-purpose computing apparatus and may execute program code to perform any of the functions described herein. The apparatus 700 may be associated with, for example, the monitoring platform 550 of the computer system 500 illustrated in FIG. 5. The apparatus 700 may include other unshown elements according to some embodiments.

The apparatus 500 includes a processor 710 operatively coupled to a communication device 720, a data storage device 730, one or more input devices 740, one or more output devices 750, and a memory 760. The communication device 720 may facilitate communication with external devices, such as a reporting client, a data storage device, or elements of a computer system being monitored. The input device(s) 740 may comprise, for example, a keyboard, a keypad, a mouse or other pointing device, a microphone, knob or a switch, an Infra-Red (“IR”) port, a docking station, and/or a touch screen. The input device(s) 740 may be used, for example, to enter information into apparatus 700 such as rounding information, report generation requests, etc. The output device(s) 750 may comprise, for example, a display (e.g., a display screen) a speaker, and/or a printer to output monitoring data history reports.

The data storage device 730 may comprise any appropriate persistent storage device, including combinations of magnetic storage devices (e.g., magnetic tape, hard disk drives and flash memory), optical storage devices, Read Only Memory (“ROM”) devices, etc., while the memory 760 may comprise Random Access Memory (“RAM”).

A rounding engine 732 may comprise program code executed by processor 710 to cause apparatus 700 to perform any one or more of the processes described herein. Embodiments are not limited to execution of these processes by a single apparatus. The monitoring data history 734 and/or rounded monitoring data history 736 may be stored, for example, in a columnar database. The data storage device 730 may also store data and other program code for providing additional functionality and/or which are necessary for operation of apparatus 700, such as device drivers, operating system files, etc.

FIG. 8 is a tabular representation of a 7 digit monitoring data and rounded monitoring data table 800 in accordance with some embodiments. That is, the column labeled “7 digits” may correspond to the monitoring data history 734 and any of the columns labeled “6 digits” through “1 Digit” may correspond to the rounded monitoring data history 736 of FIG. 7. The table 800 of FIG. 8 represents raw data as collected once per second in a data range between 1 and 10 million (with full accuracy equaling 7 digits). The columns in the table 800 to the right illustrate the same raw data rounded to a decreasing number of digits (from 6 through 1). At the bottom of the table 800, aggregated values per column are shown as well as the deviation of aggregated rounded values from the aggregated original values, and the estimated deviation equation previously described.

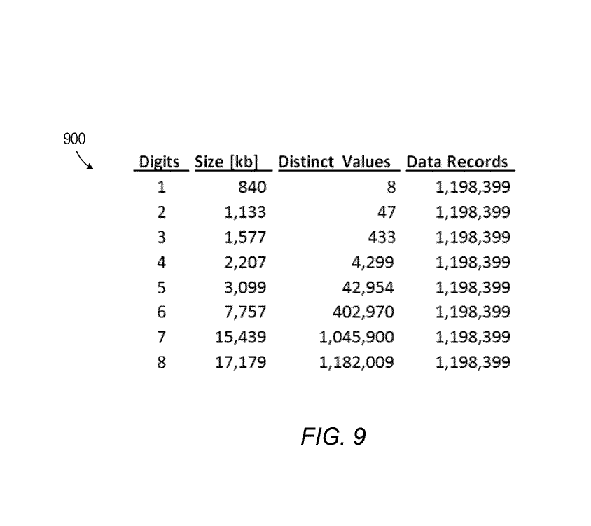

To facilitate different number ranges and scales, some embodiments described herein may use a fixed precision for all values, counting from left, of the two most significant digits. That is, a value of “1,124,345” will be rounded to “1,100,000” and a value of “193” will be rounded to “190.” FIG. 9 is a table 900 of an example illustrating various rounding scenarios according to some embodiments. In particular, the table 900 shows actual numbers of computer system with 1,198,399 data records. Rounding up the raw data to two digits (the first two, most significant digits) leads to a compression rate of substantially 15.

Note that the table 900 may show the size of the table in a database, depending on the number of relevant digits that are not rounded. Starting with the maximum of 8 digits (not rounded at all) up to 1 digit (7 digits rounded). In the case of 8 digits (not rounded at all) the table within the database has a size of 17,179 KB. In case of 2 digits (6 digits are rounded), the same table has a size of 1,133 KB. That is, 8 digits (not rounded at all) compared to 2 digits (6 digits are rounded) shows a compression factor of about 17,179 KB divided by 1,133 KB is approximately 15. In the table, the “Digits” column represents the number of unrounded digits. The original, raw, un-rounded data has 8 digits. The column “Size” in the table 900 shows the remaining table size depending on the number of rounded digits.

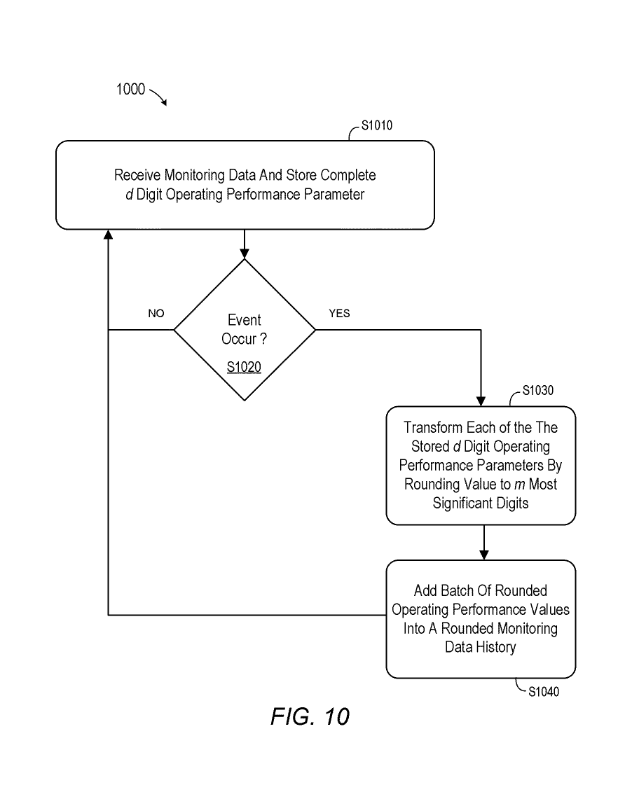

In one approach to life cycle management for historical data, the original sample data is stored in a rounded format from the beginning. That is, the transformation is performed as each operating performance parameter is received. In another approach, the original sample data may be preliminarily stored as measured with the highest accuracy (that is, un-rounded). An asynchronous job may then periodically rounds data, for which the highest accuracy is no longer needed. For example, FIG. 10 is a flow diagram of a rounding method 1000 according to some embodiments. At S1010 monitoring data is received and the complete d digital operating performance parameter is stored. At S1020, it is determined if an event has occurred. The event might comprise, for example, a predetermine amount of monitoring data being built up, an asynchronous or synchronous flag (e.g., a flag that is raised once every hour), etc. If the event has not occurred at S1020, more monitoring data is collected and stored at S1010.

When the event occurs at S1020, each of the stored d digital operating performance parameters is rounded to the m most significant digits at 51030. The batch of rounded operating performance values may then be added to a rounded monitoring data history at 51040 (and the original un-rounded values may be deleted). The method 1000 may then continue collecting un-rounded monitoring data at S1010. In this way, the rounding transformation may be performed asynchronously (or synchronously) for a plurality of received operating performance parameters upon an occurrence of an event.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of system 500 may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A monitoring platform, comprising:
a communication device to receiving monitoring data for a computer system, the monitoring data including at least one d digit operating performance parameter of the computer system;
a rounding engine, coupled to the communication device, including:
a memory storing processor-executable program code, and
a processor to execute the processor-executable program code in order to cause the rounding engine to:
access the monitoring data,
transform the monitoring data into rounded monitoring data such that the d digit operating performance parameter is rounded to preserve only the m most significant digits, m being less than d, and
output the rounded monitoring data; and
a history storage unit to receive and store the rounded monitoring data into a rounded monitoring data history.

2. The monitoring platform of claim 1, wherein the history storage unit comprises columnar data storage in an in-memory database.

3. The monitoring platform of claim 1, wherein rounding monitoring data is created for each monitoring data that is received.

4. The monitoring platform of claim 1, wherein the computer system is associated with at least one of: (i) a database system, (ii) an operating system, (iii) a virtualization layer, (iv) a cloud service, (v) an infrastructure as a service platform, (vi) a real-time analytics, interactive data exploration and application platform, (vii) a real time data acquisition platform, (viii) a transactional, analytical, online application, (ix) a customer mobile application, (x) a business object suite, and (xi) a business objects data service.

5. The monitoring platform of claim 1, wherein a deviation of the rounded operating performance parameters as compared to the operating performance parameters prior to rounding is given by the following equation:
$$σ = \sqrt{\frac{1}{n * ( n - 1 )} * {\sum }_{1}^{N} ( {X}_{i} - {y}_{i} )}$$
wherein σ is the deviation, X is the operating performance parameter, y is the rounded operating performance parameter, and N is the number of times monitoring data was received.

6. The monitoring platform of claim 5, wherein m is 2 and σ is substantially 5%.

7. The monitoring platform of claim 1, wherein the rounded monitoring data history in the history storage unit is retrieved and used to determine at least one of: (i) a standard aggregation, (ii) a sum, (iii) an exception aggregation, (iv) a maximum value, and (v) a minimum value.

8. The monitoring platform of claim 1, wherein said transformation is performed as each operating performance parameter is received.

9. The monitoring platform of claim 1, wherein said transformation is performed for a plurality of received operating performance parameters upon an occurrence of an event.

10. A non-transitory, computer-readable medium storing program code, the program code executable by a processor of a monitoring platform to cause the monitoring platform to:
receive monitoring data for a computer system, the monitoring data including at least one d digit operating performance parameter of the computer system;
automatically transform the monitoring data into rounded monitoring data such that the d digit operating performance parameter is rounded to preserve only the m most significant digits, m being less than d; and
store the rounded monitoring data within a rounded monitoring data history of a history storage unit.

11. The medium of claim 10, wherein the history storage unit comprises columnar data storage in an in-memory database, and further wherein rounding monitoring data is created for each monitoring data that is received.

12. The medium of claim 10, wherein the computer system is associated with at least one of: (i) a database system, (ii) an operating system, (iii) a virtualization layer, (iv) a cloud service, (v) an infrastructure as a service platform, (vi) a real-time analytics, interactive data exploration and application platform, (vii) a real time data acquisition platform, (viii) a transactional, analytical, online application, (ix) a customer mobile application, (x) a business object suite, and (xi) a business objects data service.

13. The medium of claim 10, wherein a deviation of the rounded operating performance parameters as compared to the operating performance parameters prior to rounding is given by the following equation:
$$σ = \sqrt{\frac{1}{n * ( n - 1 )} * {\sum }_{1}^{N} ( {X}_{i} - {y}_{i} )}$$
wherein σ is the deviation, X is the operating performance parameter, y is the rounded operating performance parameter, and N is the number of times monitoring data was received.

14. The medium of claim 13, wherein m is 2 and σ is substantially 5%.

15. The medium of claim 10, wherein the rounded monitoring data history in the history storage unit is retrieved and used to determine at least one of: (i) a standard aggregation, (ii) a sum, (iii) an exception aggregation, (iv) a maximum value, and (v) a minimum value.

16. The medium of claim 10, wherein said transformation is performed as each operating performance parameter is received.

17. The medium of claim 10, wherein said transformation is performed for a plurality of received operating performance parameters upon an occurrence of an event.

18. A computer-implemented method, comprising:
receiving monitoring data for a computer system, the monitoring data including at least one d digit operating performance parameter of the computer system;
automatically transforming, by the rounding engine processor, the monitoring data into rounded monitoring data such that the d digit operating performance parameter is rounded to preserve only the m most significant digits, m being less than d; and
storing, by the rounding engine processor, the rounded monitoring data within a rounded monitoring data history of a history storage unit.

19. The method of claim 18, wherein the history storage unit comprises columnar data storage in an in-memory database, and further wherein rounding monitoring data is created for each monitoring data that is received.

20. The method of claim 18, wherein the computer system is associated with at least one of: (i) a database system, (ii) an operating system, (iii) a virtualization layer, (iv) a cloud service, (v) an infrastructure as a service platform, (vi) a real-time analytics, interactive data exploration and application platform, (vii) a real time data acquisition platform, (viii) a transactional, analytical, online application, (ix) a customer mobile application, (x) a business object suite, and (xi) a business objects data service.

21. The method of claim 18, wherein said transformation is performed as each operating performance parameter is received.

22. The method of claim 18, wherein said transformation is performed for a plurality of received operating performance parameters upon an occurrence of an event.
